(19) United States
(12) Patent Application Publication
(10) Pub. No.: US 2002/0116716 A1
(43) Pub. Date: Aug. 22, 2002

(54) Online video editor

(76) Inventor: Adi Sideman, New York, NY (US)

Correspondence Address: FITZPATRICK CELLA HARPER & SCINTO, 30 ROCKEFELLER PLAZA, NEW YORK, NY, 10112, US

(21) Appl. No.: 09/790,991

(22) Filed: Feb. 22, 2001

(51) Int. Cl. H04N 7/173

(52) U.S. Cl. 725/91; 725/86; 725/114; 725/116

(57) ABSTRACT

A method is provided that runs on a server operating on a network having a client/server architecture to allow a client control over a video editor program running on the server. The method includes: receiving from a client user choices for audio/visual media available on the server and/or audio/visual media uploaded from the client, presenting the client with a real time control panel to allow the client to control the video editor program to create a video from the chosen and/or uploaded audio/visual media, saving the video clip as an edit-decision list on the server side, composing and streaming audio and video content to the client in real time to allow the video to be played by the client in a manner optimal to the client's environment.

### MICROFICHE APPENDIX

There are 7 microfiche in total, and 466 frames in total.

### BACKGROUND OF THE INVENTION

1. Field of the Invention

The present invention relates to the field of online interactive multi-media, and more particularly to a system and method that enables users to create and edit their own customized videos, movie trailers, short films, animations, commercials, and other media-rich content online.

2. Description of the Related Art

The development of the Internet and related information sharing technologies has allowed users to have more control over their media and entertainment. For example, the availability of compressed digital music files, such as those encoded by the MP3 compression technique, has allowed people to readily acquire and/or share digital files representing recorded music over the Internet, and compile mixes of their favorite music. However, this practice, and other peer-to-peer practices, makes it difficult for content providers to add value to their branded content, and in fact, in the case of the sharing of copyrighted material over the Internet, may be seen by content providers as coming at the expense of the rights of the content creators and/or owners to their intellectual property.

At the core of the Web is content. According to Cyber Dialogue's American Internet User Survey, Q3 2000, approximately 80% of all online users are currently accessing entertainment content on the Web. However, the present technologies do not offer branded content providers with enough ways to provide an entertainment experience to their user base and generate revenue and brand recognition at the same time.

The proliferation of peer-to-peer trading of branded content makes clear the demand for such content by online users. In addition to desiring access to this branded content, users have expressed a growing desire for more control over their entertainment. The present peer-to-peer methodologies, as mentioned above, have their own problems in that control over the branded content may be taken completely out of the hands of content providers. Thus, there exists a need for media applications that satisfy the user's need for more control over their entertainment content while at the same time affording the content providers the fruits of their labor, as well as more control over the dissemination of their content.

Also, more than ever before, online users are generating their own content, especially visual content. For example, with the advent of digital camera technology, such users have used this content in making their own Web sites or for e-mailing to friends and relatives. However, to allow users even more control over their entertainment, there is a need for online users to be able to combine their own content with branded content to fully personalize the online entertainment experience.

Customized Internet greeting cards are known. Such services allow users to select from whimsical audio and video content to format a video greeting card, which is usually delivered by e-mail.

However, while such audiovisual creation entails some creativity in the arrangement and selection of the media, the activity, being purely for the purpose of sending greetings, does not include the ability to select specific media elements and describe how they will be composed. This does not satisfy the abstract need for an outlet for a user's creativity.

In addition, the resultant multimedia greeting is typically delivered in its entirety, or a link to the complete greeting is delivered. This, in contrast to the method described herein, requires content to be duplicated and therefore limits to a very large degree the possibility of providing personal creativity experience due to the significant resources required. Moreover, the content available for the greeting cards generally is not branded content, nor can the user upload his or her own content to add to that available from the site.

In addition, when listing the deficiencies of prior art we should note that: no current system allows for editing of networked media within the browser window, with the administrator's ability to export that creation to a broadcast quality instance of the creation; Addition of User Uploaded audio is not currently available into existing web media application; User input of text is currently not synchronized to user specified moving image events; No existing media editor connects to established online content libraries, or web based media search engines, to allow users to sift through and select from the vast media resources available on the network.

Thus, there exists a need to allow users to exercise their creativity, and facilitate media based communications by interacting with branded content, as well as, or in combination with, user-provided, networked, or other content.

### SUMMARY OF THE INVENTION

In view of the above deficiencies of the prior art, there is provided a system that allows real-time client-server interactive editing of edit-decision lists for the purpose of efficient creation or editing of videos and animations online. The system is exceptionally efficient in storage requirements and also allows real-time optimization to the playback environment. This capability allows optimized support for online playback at diverse bandwidths as well as for playback on other devices such as television and wireless devices.

There also is provided a system that allows users to exercise their own creativity by combining their own content with the published content in creation of videos online.

In addition, an Administration tool allows community managers and content editors to administer the media based application, add and arrange new content, censor user creations, select user creations for playback online or on television and create new instances of the editing environment for alternative content programming.

In accordance with one aspect of the present invention, there is provided an apparatus operating on a network having a client/server architecture to allow a client control over a video editor program running on the server. The apparatus comprises: means for receiving from a client user choices for audio/visual media available on the server and/or audio/visual media uploaded from the client; means for presenting the client with a real time control panel to allow the client to control the video editor program to create a video from the chosen and/or uploaded audio/visual media; means for streaming audio and video content to the client in real time to allow the video to be played by the client as it is being created; and means for saving the completed video in the form of one or more edit decision lists without having to store the constituent media, allowing for efficient storage and optimized playback.

In accordance with another embodiment of the present invention, there is provided a method running on a server operating on a network having a client/server architecture to allow a client control over a video editor program running on the server. The method comprises: receiving from a client user choices for audio/visual media available on the server and/or audio/visual media uploaded from the client; presenting the client with a real time control panel to allow the client to control the video editor program to create a video from the chosen and/or uploaded audio/visual media; streaming audio and video content to the client in real time to allow the video to be played by the client as it is being created; and saving the completed video in the form of one or more edit decision lists without having to store the constituent media, allowing for efficient storage and optimized playback.

In accordance with yet another aspect of the present invention, there is provided a computer-readable medium for controlling a processor controlled server operating on a network having a client/server architecture. The server allows a client control over a video editor program running on the server, to perform a method comprising: receiving from a client user choices for audio/visual media available on the server and/or audio/visual media uploaded from the client; presenting the client with a real time control panel to allow the client to control the video editor program to create a video from the chosen and/or uploaded audio/visual media; streaming audio and video content to the client in real time to allow the video to be played by the client as it is being created; and saving the completed video in the form of one or more edit decision lists without having to store the constituent media, allowing for efficient storage and optimized playback.

In accordance with still another aspect of the present invention, there is provided a server operating on a network having a client/server architecture to allow a client control over a video editor program running on the server. The server is adapted to: receive from a client user choices for audio/visual media available on the server and/or audio/visual media uploaded from the client; present the client with a real time control panel to allow the client to control the video editor program to create a video from the chosen and/or uploaded audio/visual media; stream audio and video content to the client in real time to allow the video to be played by the client as it is being created; and save the completed video in the form of one or more edit decision lists without having to store the constituent media, allowing for efficient storage and optimized playback.

In accordance with another aspect of the present invention, there is provided an apparatus, comprising a server processor coupled to a user via an on-line connection. The server processor is adapted to: allow the user to edit audio/video content on-line; and create an edit list of edits with the edit list stored on the server processor.

In accordance with another aspect of the present invention, there is provided an apparatus comprising: a server processor, the server processor being adapted to:

store audio/video content and an edit list for the content;

transmit an edit control interface used for communicating with the server processor; and create the edit list and download edited content when requested by editing the content with the edit list; and a client processor coupled to the server processor, the client processor being adapted to receive the interface, and allow a user to on-line edit the content stored on the server processor using the interface and create the edit list.

In accordance with another aspect of the present invention, there is provided a method comprising: allowing a user to interactively edit remotely stored audio/video content producing an edit list; and storing the edit list remotely in association with the content.

### BRIEF DESCRIPTION OF THE DRAWINGS

FIG. 1 is a block diagram of the system architecture of the video editor of the present invention;

FIG. 2 is an exemplary graphical user interface (GUI) screen for introducing the user to the video editor of the present invention;

FIG. 3 is an exemplary GUI screen introducing the mix your own clips application of the present invention;

FIG. 4 is an exemplary GUI screen for selecting an audio component to be used by the video editor of the present invention;

FIG. 5 is an exemplary GUI screen for selecting an image component to be used by the video editor of the present invention;

FIG. 6 is an exemplary GUI screen for selecting an animations component to be used by the video editor of the present invention;

FIG. 7 is an exemplary GUI screen for selecting a movie component to be used by the video editor of the present invention;

FIG. 8 is an exemplary GUI screen for showing media that has been selected by the user;

FIGS. 9A-9C are control screens for allowing the user to remotely control the operation of the video editor of the present invention;

FIG. 10 is an exemplary GUI screen for introducing the view all clips application of the video editor of the present invention;

FIG. 11 is a control screen for allowing the user to remotely the operation of the video editor of the present invention in the play mode;

FIG. 12 is a diagram showing the system architecture of the user interface of the video editor of the present invention; and

FIG. 13 is a sample screen for utilizing the administration tool of the present invention.

### DETAILED DESCRIPTION OF THE PREFERRED EMBODIMENTS

“Computer” may refer to a single computer or to a system of interacting computers. Generally speaking, a computer is a combination of a hardware system, a software operating system and perhaps one or more software application programs. Examples of computers include, without limitation, IBM-type personal computers (PCs) having an operating system such as DOS, Windows, OX/2 or Linux; Macintosh computers; hardware having a JAVA-OS operating system; graphical work stations, such as Sun Microsystems and Silicon Graphics Workstations having a UNIX operating system; PalmPilots; and PilotPCs.

“Network” means a connection between any two or more computers, which permits the transmission of data. An example of a network is the Internet.

“Client/server” architecture is a network architecture in which each computer or process on the network is either a “client” or a “server”. A “server” is a computer or device on a network that manages network resources and is operable to receive requests from third parties on the network and respond to those requests. Requests are sent to a server by a “client”, typically an application that runs on a personal computer or workstation and relies on the server to perform some operations.

“Web page” means any documents written in mark-up language including, but not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web site” means at least one Web page, and preferably a plurality of Web pages, virtually connected to form a coherent group.

“Web browser” means any client software program running on a computer which can display text, graphics, or both, from Web pages on Web sites. Examples of Web browsers include, without limitation, Netscape Navigator and Microsoft Internet Explorer.

“Web server” is a server which is capable of serving at least one Web page to a Web browser.

The phrase “display a Web page” includes all actions necessary to render at least a portion of the information on the Web page available to the computer user. As such, the phrase includes, but is not limited to, the static visual display of static graphical information, the audible production of audio information, the animated visual display of animation and the visual display of video stream data.

For the present invention, a software application could be written in substantially any suitable programming language, which could easily be selected by one of ordinary skill in the art. The programming language chosen should be compatible with the computer by which the software application is executed, and in particular with the operating system of that computer. Examples of suitable programming languages include, but are not limited to, C, C++, CGI, Java and Java Scripts. Furthermore, the functions of the present invention, when described as a series of steps for a method, could be implemented as a series of software instructions for being operated by a data processor, such that the present invention could be implemented as software, firmware or hardware, or a combination thereof.

The present invention is an online system that, in a preferred embodiment, operates to provide to users an online audio video editor, operating at a Web server, with which the users can make shot by shot decisions to create custom videos for playback within a web environment. Because of the way that editing actions are recorded, this system could also be used to generate high quality video playback through a broadcast based distribution medium such as television, cable, interactive TV. A user, operating a terminal running client software, such as Web browser software, can select archived audio and visual media, or upload his or her own media, or search associated libraries and compatible networked media, then edit those assets using a powerful array of video editing transitions and visual and audio effects by interacting online with the video editor. In addition to video editing and creation, the present invention allows end users to post their creations on the Web, for various purposes, such as for example, to compete in contests, or to be selected by an administrator to be distributed as programming on a TV or Cable network.

An extremely advantageous feature of the present invention is that the user manipulates media in a manner that makes it appear that he or she has created a video file for permanent storage. However, what is actually being created is an edit decision list. The edit decision list consists of a record corresponding to the editing commands that went into creation of the video by the user. Since the server of the video editor Web site only stores the edit decision list, and does not store a file containing a complete video, storage space is saved at the server. When someone wishes to playback the video, the video mixer uses the edit decision list to reassemble the video from constituent media content.

The edit-decision list is a record of all actions undertaken by the user during an editing session. As the user “records” a video, the following information is recorded per editing action:

Time—the precise moment the action occurred, measured in milliseconds from the beginning of the recording

Asset-id—identifies the specific media element selected

Transition-id—identifies the transition that was used.

A sample edit decision list follows:

<CLICK trans=“5” id=“2173” tick=“13” />

<CLICK trans=“5” id=“2153” tick=“233” />

<CLICK trans=“5” id=“2173” tick=“393” />

<CLICK trans=“5” id=“2161” tick=“740” />

<CLICK trans=“5” id=“2186” tick=“1080” />

<CLICK trans=“5” id=“2176” tick=“1313” />

<CLICK trans=“5” id=“2186” tick=“1526” />

<CLICK trans=“5” id=“2173” tick=“1826” />

<CLICK trans=“5” id=“2153” tick=“2193” />

<CLICK trans=“5” id=“2173” tick=“2386” />

<CLICK trans=“5” id=“2180” tick=“2573” />

<CLICK trans=“5” id=“2176” tick=“2946” />

<CLICK trans=“5” id=“2180” tick=“3140” />

<CLICK trans=“5” id=“2153” tick=“3326” />

<CLICK trans=“5” id=“2173” tick=“3513” />

<CLICK trans=“5” id=“2180” tick=“3693” />

This method has two important advantages over saving an entire finished video. First, because the “videos” are composed only on an as-needed basis, and immediately delivered, they are never permanently stored in their composed form. This enables the video editor of the present invention to feasibly serve a large number of online users, as storage of the users' creation requires very few resources.

Second, because the video is composed only as needed, according to users' requests, the video can be optimized to the playback environment. This means that, for example, the video can be created once, on a 56K connection, but viewed in any one of a number of connection speed and media environments, e.g., 56K, T1, television, even wireless—in each case taking full advantage of the quality and features available to that environment. For example, because of limited bandwidth, when the user of the system creates the video over a 56K connection, the music and video/image portions of his or her video are fed back in relatively low-resolution formats, to allow for as close to a real time experience as possible. However, because only pointers to the content are stored in the server, when a broadband viewing outlet is available, such as T1, cable, or broadcast television, high resolution versions of the selected content could be woven together by using the very same stored edit decision list.

Preferably the software application or applications comprising the editor are deployed in a Web server that employs a front end built with HTML, JavaScript, and Flash. The system preferably is implemented to allow a client operating on a user terminal to interface with the server without the need for browser plug-ins, aside preferably from a Macromedia Flash plug-in. The audio and visual content that is to be made available to the user for making his or her videos is contained in an asset library located on the server. An editing software module residing in the server supplies the processing necessary for responding in real time to users' directions for editing the audio and video content. The user enters the directions by interacting with a virtual video editor control panel displayed on his or her computer screen. According to a preferred embodiment, audio is streamed to the user, which accelerates the speed of the user's experience. The invention preferably supports MP3 music files, Flash movie files and Joint Photographic Experts Group (JPEG) graphics.

The system of the present invention is preferably implemented at a server side in a client/server based network, such as the Internet, and more specifically, the World Wide Web (the Web). As described above, the server front end functionality presents the user with a graphical user interface (GUI) consisting of static HTML pages or Macromedia Flash pages, and dynamic downloaded content within these pages. Various control “buttons” displayed on the pages allow the user to control the server based editor, thus allowing the user to edit his or her videos from assets available at the site, or from assets uploaded by the user, or from a combination of the two. The present invention also makes available to the user advanced mixing and transitional techniques such as those in professional video editing.

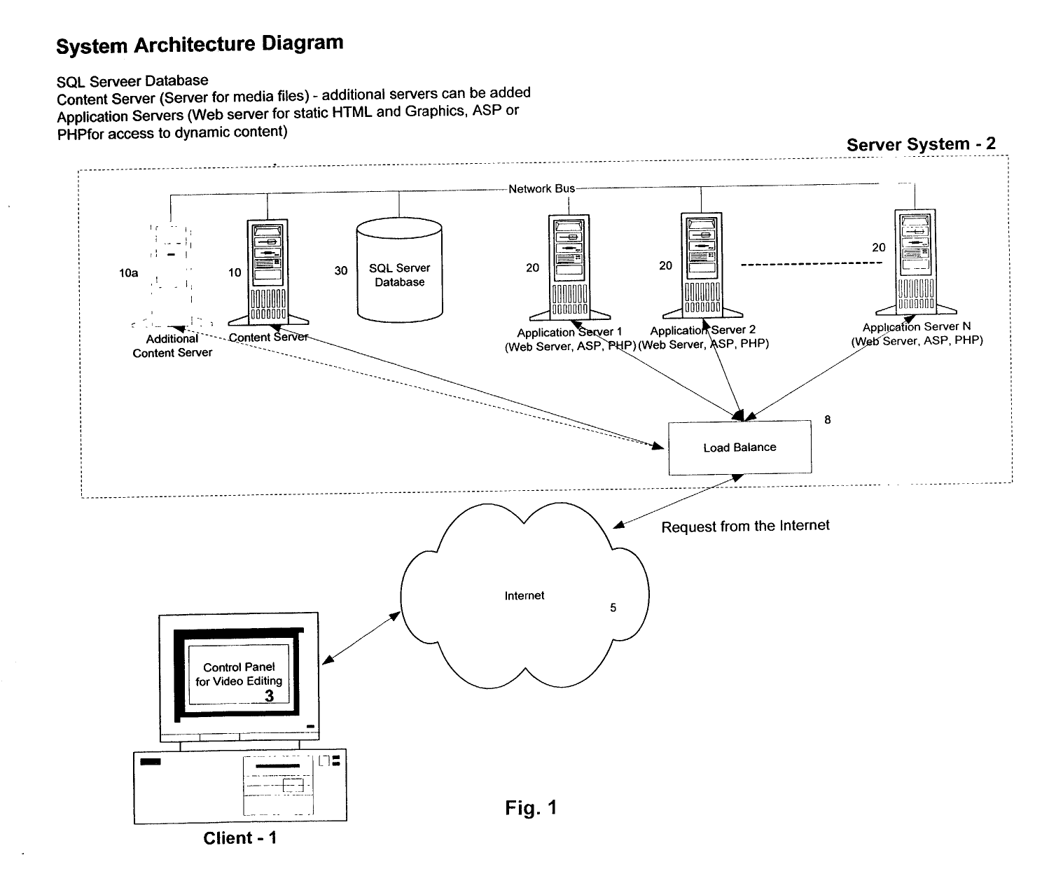

FIG. 1 shows an exemplary system architecture for the present invention. The present invention preferably is implemented by combined hardware and software running at a client 1 and a server system 2. When a user accesses the server system 2 from the client 1 over the internet 5 a control panel interface 3 is downloaded from an application server 20 to the client 1. The user interacts with the control panel 3 to select content from the content server 10, based on links and options provided by the database 30.

The user edits the content by performing point and click operations, such as

selecting media assets for use in the editing of a new video

selecting the sequence of media assets during editing

selecting transitions to be used during editing

These operations produce edit commands and query requests that are sent to the application server 20.

The application server 20 records all edit commands as an edit list in the database server 30, and interfaces with the database server 30 to execute any queries and return the results thereof to the control panel 3 for display.

Requests received over the Internet 5, typically consisting of one or more URLS, including those generated by hyperlinks at the browser, are input to an application server 20 through load balance 8. The load balance 8 is responsible for distributing the load evenly among the application servers 20. Application servers or servers 20 contain software including active server pages (ASP) and Personal Home Page (PHP), as well as static HTML pages and Flash-based objects, to present an appropriate interface to the user.

In a preferred embodiment, a program such as Microsoft's Internet Information Server (IIS) is used as the Web server. Active server pages (ASP) run as the application server component 20, 20a. For Web pages and Web sites that are to serve up static Web pages for display, IIS preferably functions by itself to provide the information. However, when a Web application demands a dynamic display of information, the Web serving capabilities of IIS preferably are linked with the dynamic page generation and object integration capabilities of ASP.

Also included in the application server is a Flash generator, a component used in initializing a Flash module and in formatting uploaded still images in a way most convenient for the Flash module to handle. The Flash module is downloaded by every client from the server side to the client side, and is executed on the client side.

Media components (images, animations and movies) are downloaded from the server to the client in an optimized manner so as to minimize the amount of data the client must download.

The user selects media components from large libraries. These media components are each represented by a small thumbnail image for the purpose of enabling the user to make a selection. Only those media components that are selected are downloaded to the client side to facilitate playback.

In addition, the process of downloading the thumbnail images that represent the media components is also optimized. This is achieved by automatically selecting for download only those thumbnails that are relevant to the context, depending on the user's previous choices.

Industry standard techniques are used to configure a 2 or 3 tier web application back-end according to FIG. 1.

The ASP components preferably include Aspmail™, which allows SMTP mail to be sent directly from a Web page, Aspimage™ which allows images to be created or modified “on the fly” and Aspupload, an Active Server component that allows an ASP application to accept, save and manipulate files uploaded with a browser. The files are uploaded via an HTML post form with one or more <INPUT TYPE=FILE> tags. The config.asp file preferably is used to set the e-mail SMTP server as well as the content server virtual path. The SMTP Server is responsible for sending out email messages in response to user requests. It is installed on the Application Server. The content server virtual path determines the logical name for the physical location of the media assets on the content server.

The add DB (database) connection string is as follows:

No DSN configuration is necessary. But check the db connection string in config.asp to confirm the server, user id, and password are correct.

SQLServer Settings

Server

Database

Username

Password

Const gConnectionString =“driver={SQL Server};server=>>{servername};database=Videomixer;uid=s a;password=sa”

As can be seen from FIG. 1, the architecture is such that the system is scalable. For example, as the number of requests increases, application servers can be added indefinitely, using standard load balancing software. All shared data for use in the video editor of the present invention is held in the content server(s) 10, 10a, and DB servers, indicated in the figure as the SQL Server Database. Different media types can be stored in different content servers.

The type of media content supported by the present invention will be described as follows. The supported content described below is optimized for allowing a user to manipulate media with the video editor even with a 56K connection. Once the edit decision list has been created for a video and stored, other media formats may be substituted as appropriate to take advantage of available bandwidth of the playback environment.

With regard to audio, the video editor of the present invention preferably uses Shockwave-Flash Audio files (SWF). Wave, AIFF and other audio formats can be used if they are converted to SWF before upload to the server. Preferably, the server is programmed to recognize the format of uploaded content and automatically and transparently convert the content into one of the formats usable by the online editor.

As has been discussed above, in a preferred embodiment, it is a design goal of the present invention to keep the content file size as small as possible, at least in the editing phase, to accommodate end users with a 56K modem connection. with regard to audio files for example, to reduce file size, the “MONO” setting should be used, the bit rate should be set to 24, and a portion of the song used in the video, rather than the full track, should be extracted. A preferred size would be 500K or less. The invention is not limited by the preferred size constraints, and of course, because preferably only edit decision lists are ultimately stored, there is no limit to the file size for playback-specific content.

With regard to still images, the video editor of the present invention preferably uses JPEG files. The image size preferably should be 240 by 180 pixels. The ASP preferably is structured to create, using a commercially available ASP server side plug-in, small thumbnails automatically when the images are added to the database at the server side.

It should be noted that America Online (AOL) has its own compression filter that will degrade the quality of jpeg images more than 8K in size. The present invention preferably avoids this problem by saving the jpeg as 3-pass progressive jpg, which the AOL filter does not recognize, or, alternatively, by making sure that the jpeg file is not over 8K in size.

With regard to movies, the video editor, rather than utilize Quicktime movies, preferably achieves a simulation of a movie by the animation of sequenced bitmaps in Flash. Any known video-editing program may be used to edit source video. The size of the movie should be 240×180 pixels. The edited movies should be short loop-able clips. From the video editing software, sequenced bitmaps are exported out at a range of 5-25 frames per second. If the video editing software chosen does not allow selection of a lower frame rate, a technician at the server side will have to manually select from the sequenced bitmaps the number of images that correspond to approximately 5 frames per second. To achieve the lowest possible file size, the bitmaps should then be converted into “png” format, which is more native to Flash. This can be done through any image editing/compression program (Photoshop, ImageReady). The technician should then import the compressed images into Flash and export them as a .swf file. To facilitate the importing of numerous images, the images should be named in a sequence (eg. dance1.png, dance2.png, dance3.png, etc.) and put into one folder. The preferred target file size for the swf should be 60 k or less. The file size will depend on the number of images to be imported into Flash.

Animations supported in the video editor of the present invention are actually Flash 3/Flash4/Flash5 movies. The dimension of the Flash movie preferably should be 240×180 pixels. When the home-end user publishes his or her Shockwave-Flash (SWF), he or she preferably will be afforded the opportunity to select a 240×180 image that will serve as the representative thumbnail for the video. When Flash movies are added to the database, the ASP will automatically create the small thumbnails. Also, when Flash movies are created, the ASP adds a background layer rather than simply specifying a background color. This method allows for the best results when using transitions within the video editor.

To allow for a Flash movie to stop when using the “Pause” function of the video editor, to be discussed below, the Flash movie should contain no “movie clips”. Instead, the same effect preferably is achieved using an animated symbol that is dependent on the main timeline of the Flash movie. Flash movie clips have timelines that are independent of the main movie. Flash animations should be approximately 15-20K in size for vector only art or under 50K for animations that contain jpeg. The smaller the size, the faster the download is for the end user.

As will be described in detail below, the present invention allows a user, operating a home computer with a client software browser, to remotely control a video editor, the processing for which is performed at the server.

Commands from the user to the editor are sent over the Internet in response to the user clicking certain displayed command buttons on HTML or Flash pages. The clicking of a command button may activate a hyperlink that causes the browser to transmit a URL that the server associates with a particular command or data file. The Flash plug-in in the browser allows the user to view streamed video and audio from the server either in a view all clips application, for viewing previously mixed videos, or a mix your own clips application, for creating new videos.

The connection between the user's clicking on a command button and the real time response of the server can be implemented in any manner that immediately correlates the user's command with an action of the editor module located at the server. In a preferred embodiment user actions that are requests for data are encoded as XML and thus transmitted to the server, where they are interpreted by a commercially available ASP plug-in that interprets the XML, and performs corresponding database query. The results are re-encoded in XML and transmitted back to client.

The functionality and end user interaction of the video editor of the present invention will now be described with reference to several figures showing exemplary GUI pages that are encountered by an end user when interacting with the video editor. The general information structures associated with the user interface will then be described. In a preferred embodiment of the present invention, the user can interact with these interactive GUI screens, which allow the user to select audio, still visuals, animations, and movies and to combine these assets to create a video.

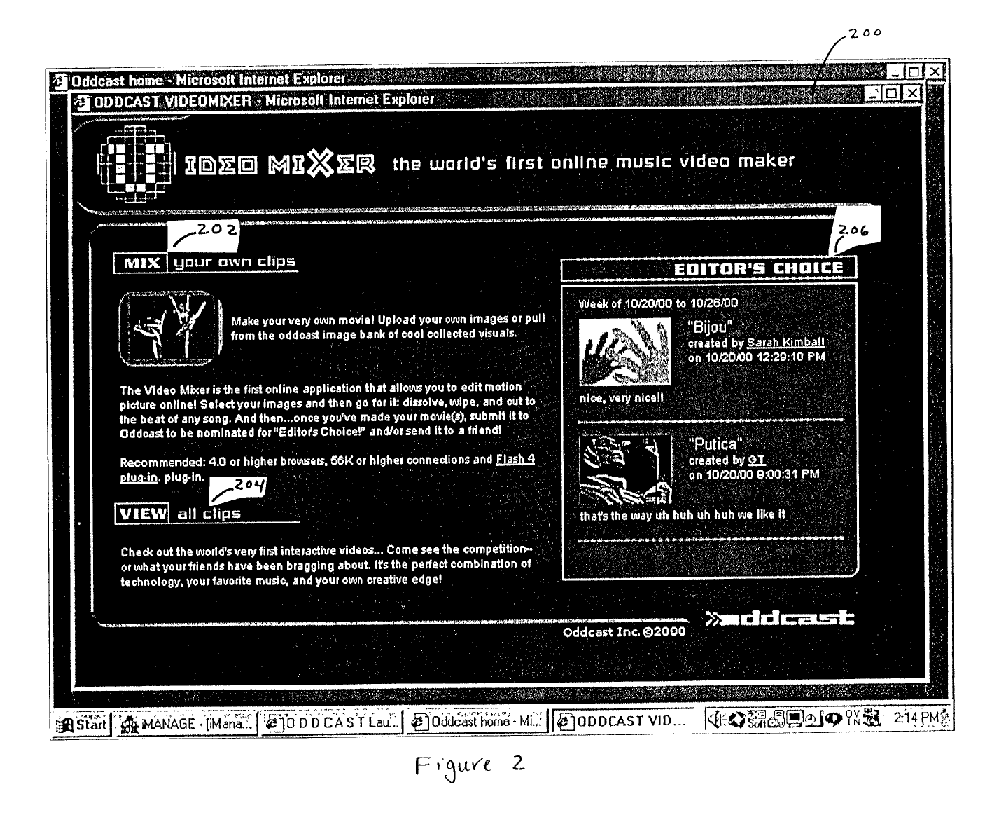

As shown in FIG. 2, the video editor entry page 200 is the first screen that a user sees within the video editor application. This page preferably allows access to two basic operations of the video editor in accordance with the present invention, namely: the mix your own clips application and the view all clips application by means of mix your own videos button 202 and view all clips button 204. This page also preferably shows an editor's choice window 206 that displays thumbnails representative of previously mixed videos that have been saved on the Web site for publication and that are considered by the system administrator to be of particular interest. Most of the subsequent pages preferably have a help button, to assist users in navigating the site. A more detailed description of the help functions will appear below.

The mix your own clips application utilizes several main pages that allow the end user to select various media from a central media bank. By interacting with these pages, the end user can select media in any order or alternatively go through the media selection pages in order as prompted by the instructions. Each media selection page allows the end user to preview his or her media selection in a pop-up window and select or deselect media to be put into a my media library window. The user also has the option to have media selected for him or her by the application itself. For that purpose, the select all for me functionality randomly selects five different media elements from within each media type, for use by the user in editing.

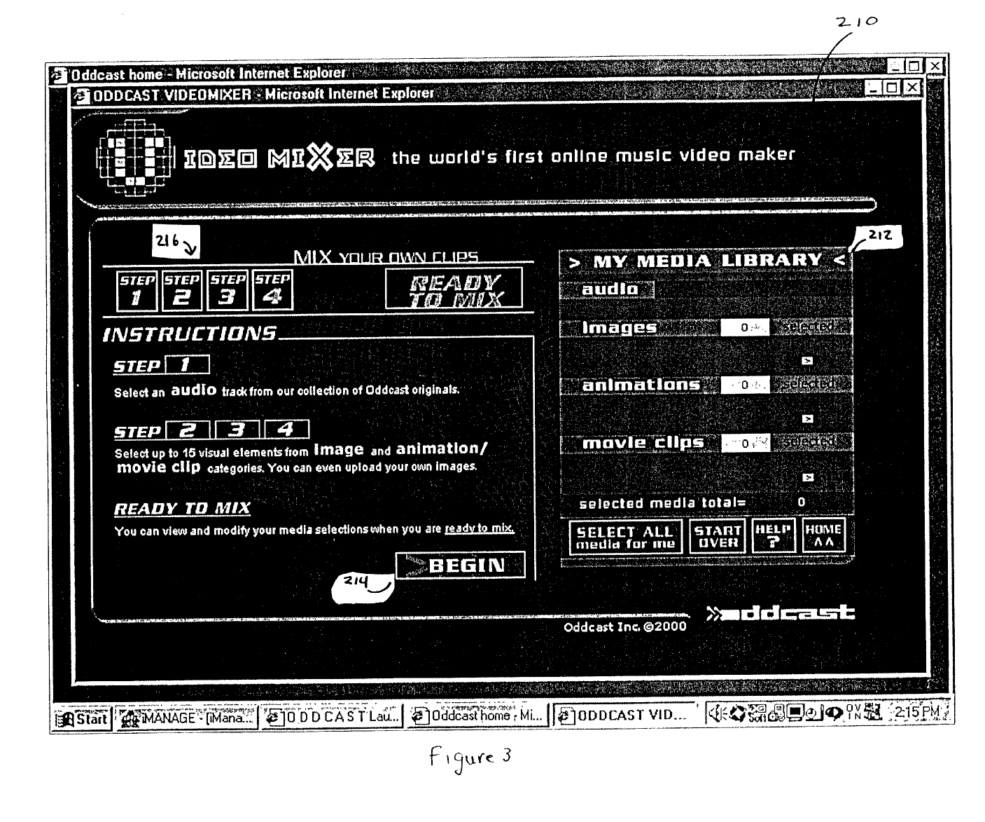

The mix your own clips application will now be described in terms of the HTML pages presented to the end user. An mix your own clips introduction page 210, shown in FIG. 3, provides basic instructions regarding the four steps for the end user to mix his or her own videos. A my media library window 212 is provided in this and subsequent pages to, as selections are made, keep the end user informed of the media selected thus far. A begin button 214 on the introduction page causes the screen for the various steps to be shown in order. The steps in the video editing process, which will be described in detail below, are introduced in the introduction page. The end user may go directly to any one of steps 1-4 if desired, by clicking the one of the step selection buttons 216 representative of that step, or may follow the default sequential order of steps.

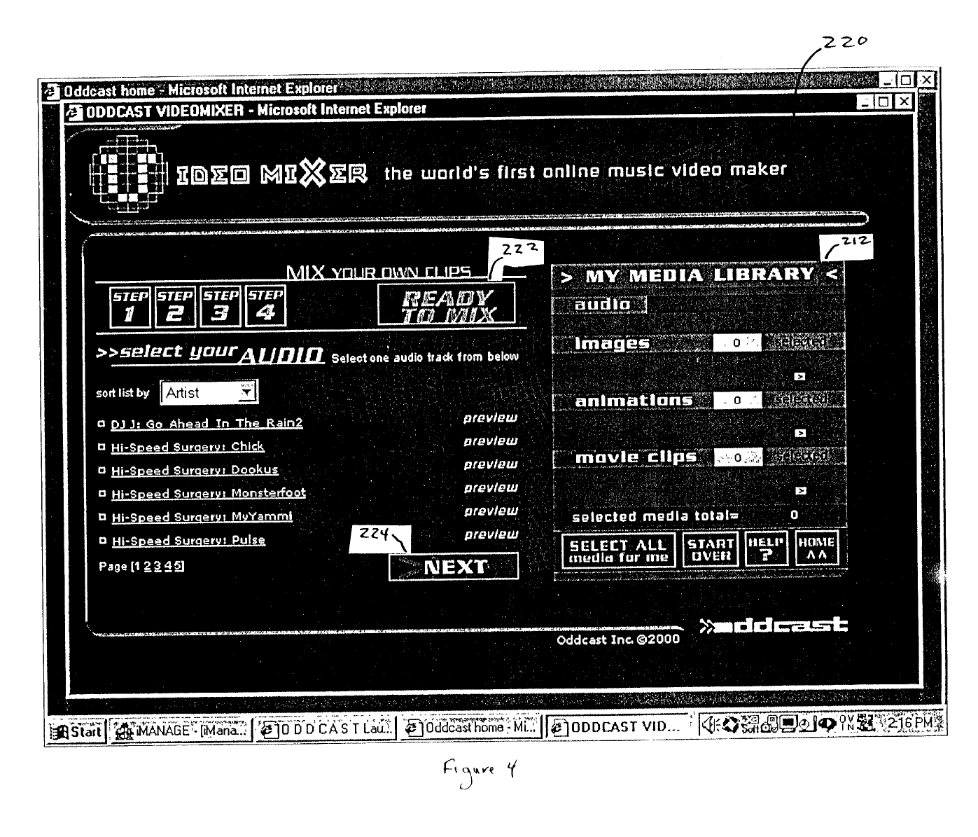

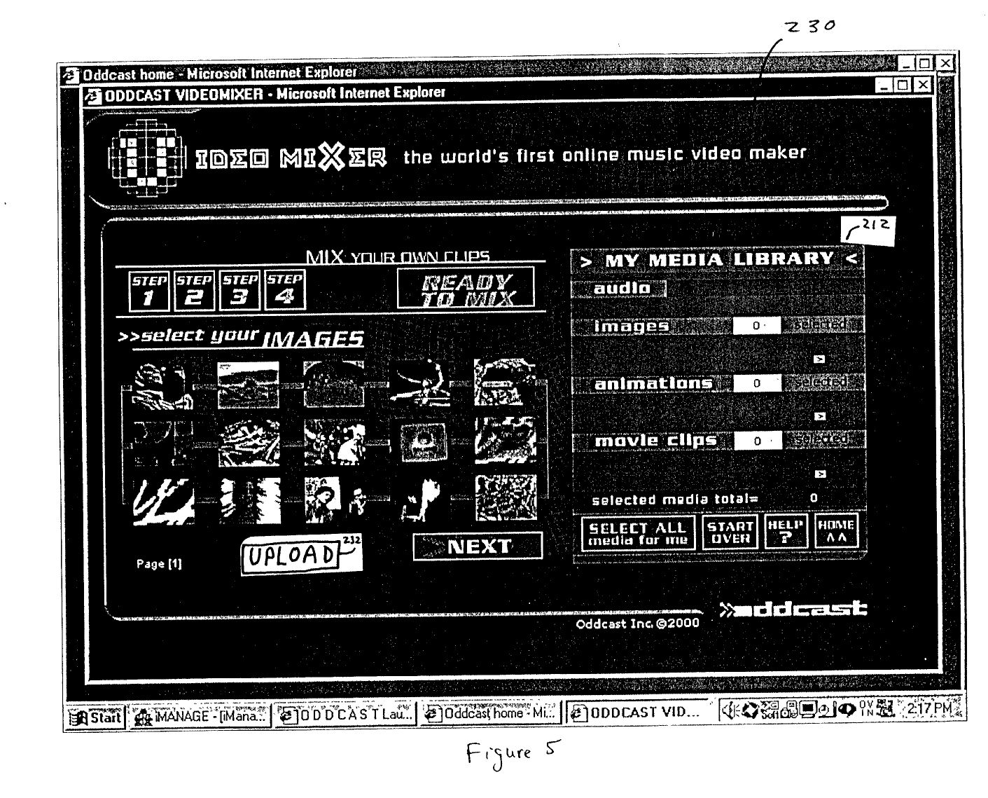

Step 1 in the video creation process is the selection of the audio track that will form the basis of the video. If the step 1 button is selected, or if the next button is clicked from the introduction page, the application proceeds to a select audio page 220, shown in FIG. 4. The select audio page 220 allows users to select and preview audio media available for use in creating the video. The page also allows a user to sort stored media by artist or song title to make it easier to find audio tracks. The my media library window 212 preferably also appears on this page, and is updated when an audio clip is selected. A ready to mix button 222 is available if the user has selected all of his or her media by the time he or she is finished with the select audio page, which may happen if the steps are not performed sequentially. If other media remains to be selected the user can go to a random one of the other three available steps by clicking the individual step buttons, or can click the next button 224, to proceed to the next step in sequence, which would be step 2. If the latter course of action is taken, a select image page, shown in FIG. 5, is next displayed.

Step 2 in the video creation process is the selection of the still image or images that will form part of the visual portion of the video. If the step 2 button is selected, or the default sequence reaches step 2, the select your images page 230, shown in FIG. 5, is displayed. This page allows end users to select and preview media, specifically image files for incorporation into videos using the video editor of the present invention. This page also allows users to upload their own still images to the database for use in editing. To upload the file, an upload button 232 is provided. The uploading is handled using the http POST command.

As can be seen in FIG. 5, the select your images page 230 displays thumbnail images of the available image files. The end user can click on one or more of the displayed thumbnails to select the images for use in creating the video. As in the select your audio page, the my media library window 212 is displayed, and is updated as the user selects the image by clicking the thumbnails.

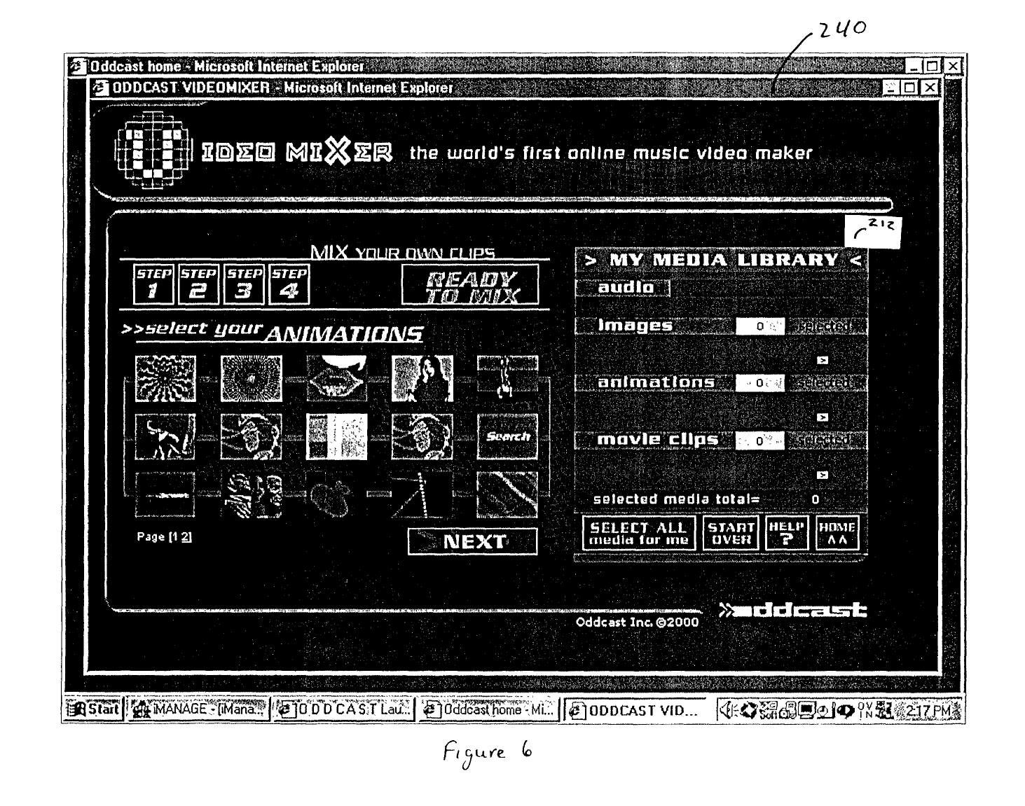

Step 3 of the video creation process is the selection of animations that will be made a part of the video. If the step 3 button is selected, or the default sequence reaches step 3, a select your animations page 240, shown in FIG. 6, is displayed, which allows users to preview and select Flash animations. At this page, the end user can select one or more animations by clicking on thumbnails representative of animations displayed on the page. Once again, the my media library window 212 is displayed and is updated as the thumbnails are clicked.

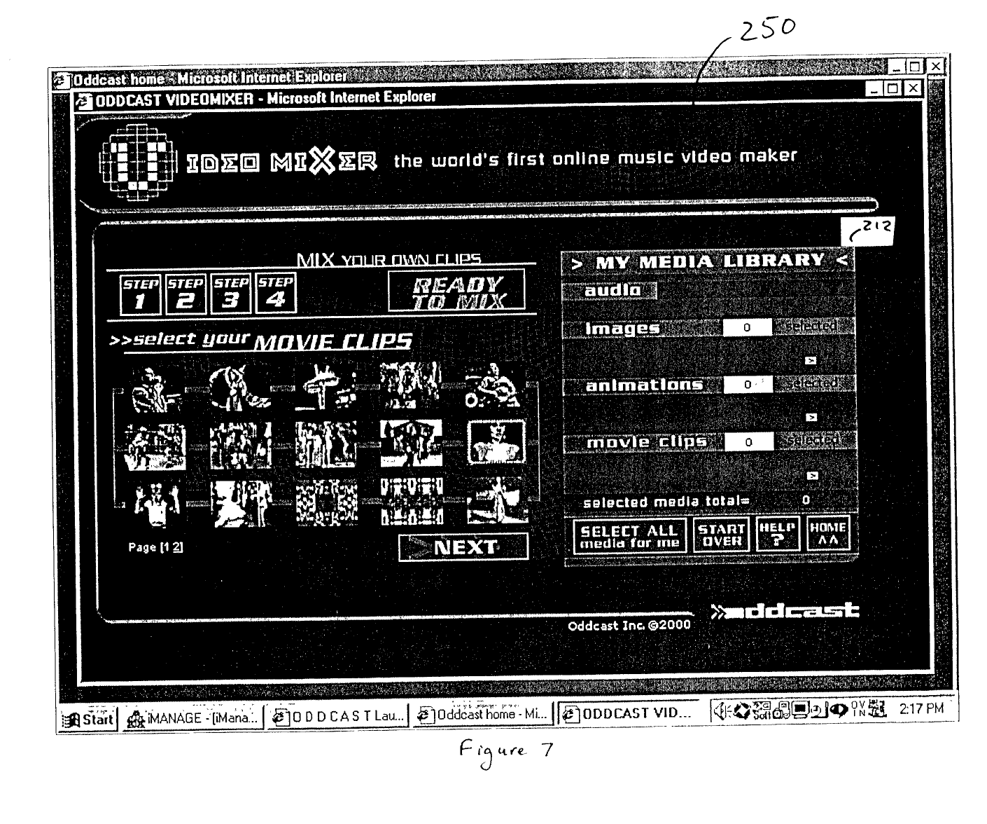

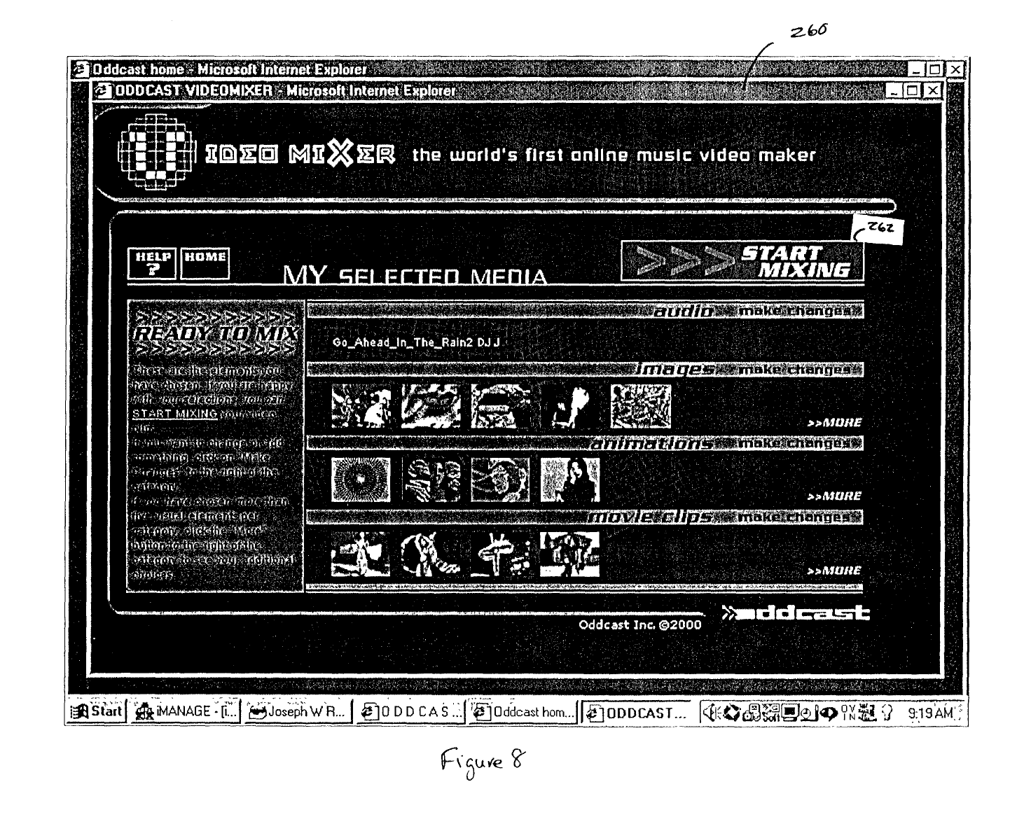

Step 4 in the video creation process is the selection of one or more movie files for use in the video. At step 4, a select your movie clips page 250, shown in FIG. 7, is displayed, which allows an end user to preview and select converted Quicktime videos by clicking on displayed representative thumbnails. As in the pages associated with steps 1-3, the my media library window 212 is displayed and is updated upon selection of a thumbnail from this page. Once steps 14 have been completed, clicking the next button will cause a my selected media page 260, shown in FIG. 8, to be displayed, which shows thumbnails of the media selected in step 1-4 and allows the user to preview the media or change and add media to their media library before starting to mix the video. A start mixing button 262 allows the user to proceed to the video editor.

Also possible is the ability to move back and forth, in a non-linear fashion between each step of the media selection process described above.

The video editor is implemented by operation, at the server, of an editing module. The editing module is a Flash 4 application with two main modes, an editing mode and a play mode.

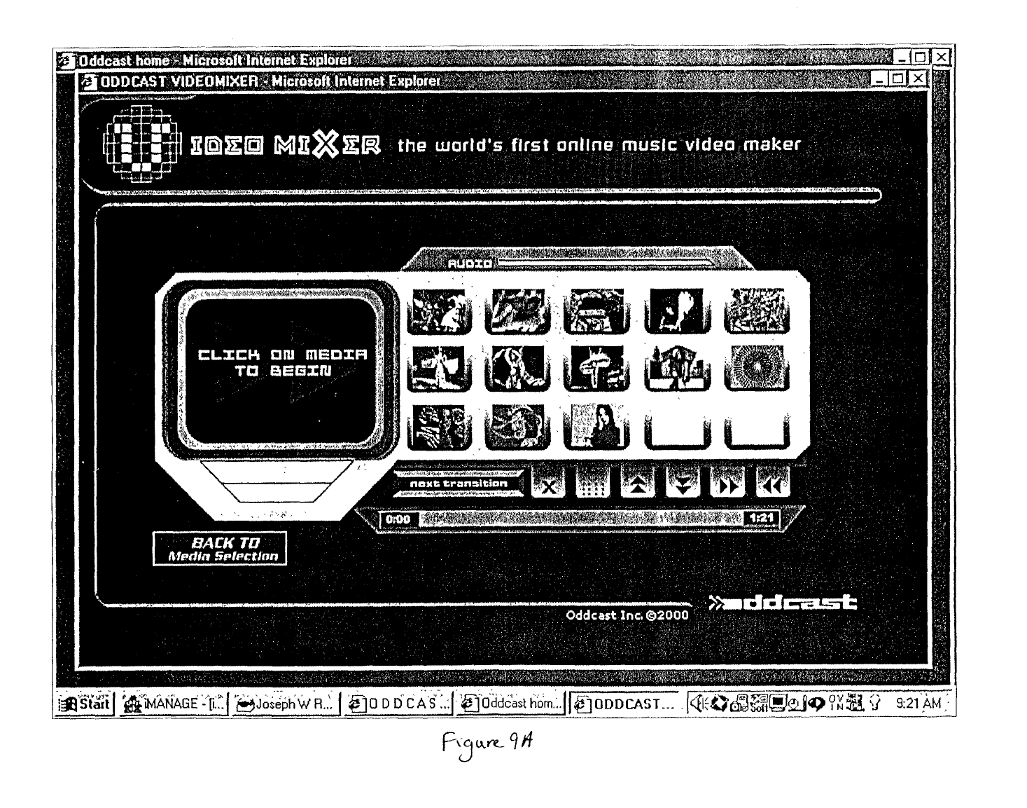

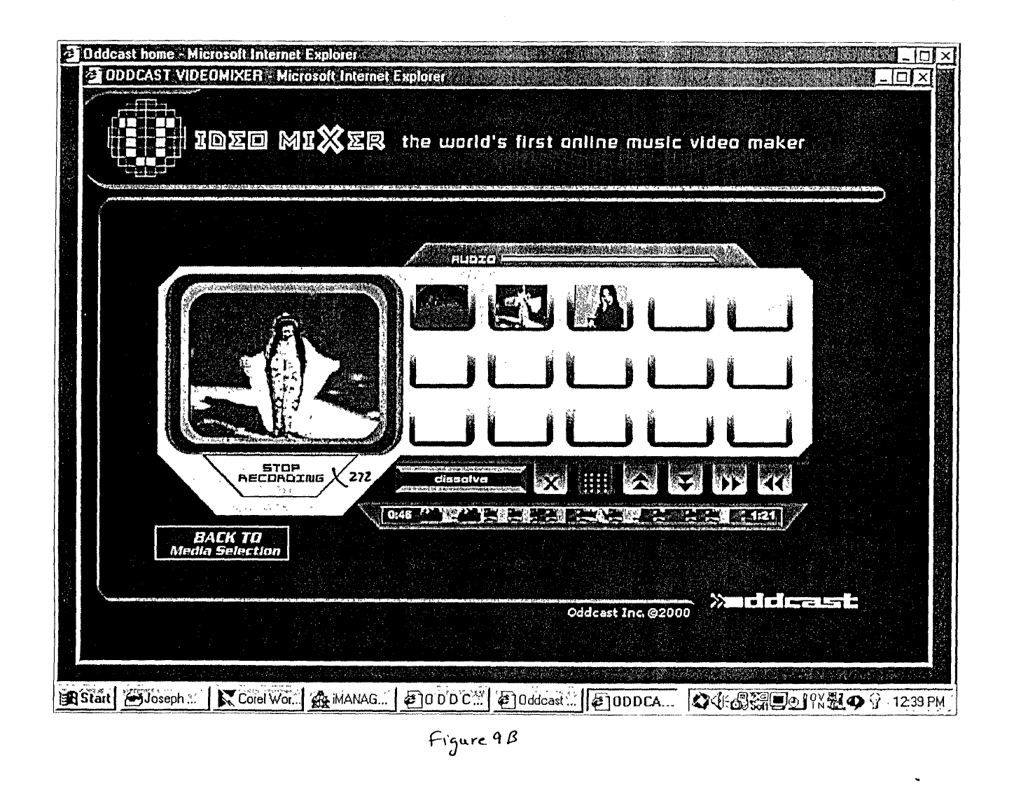

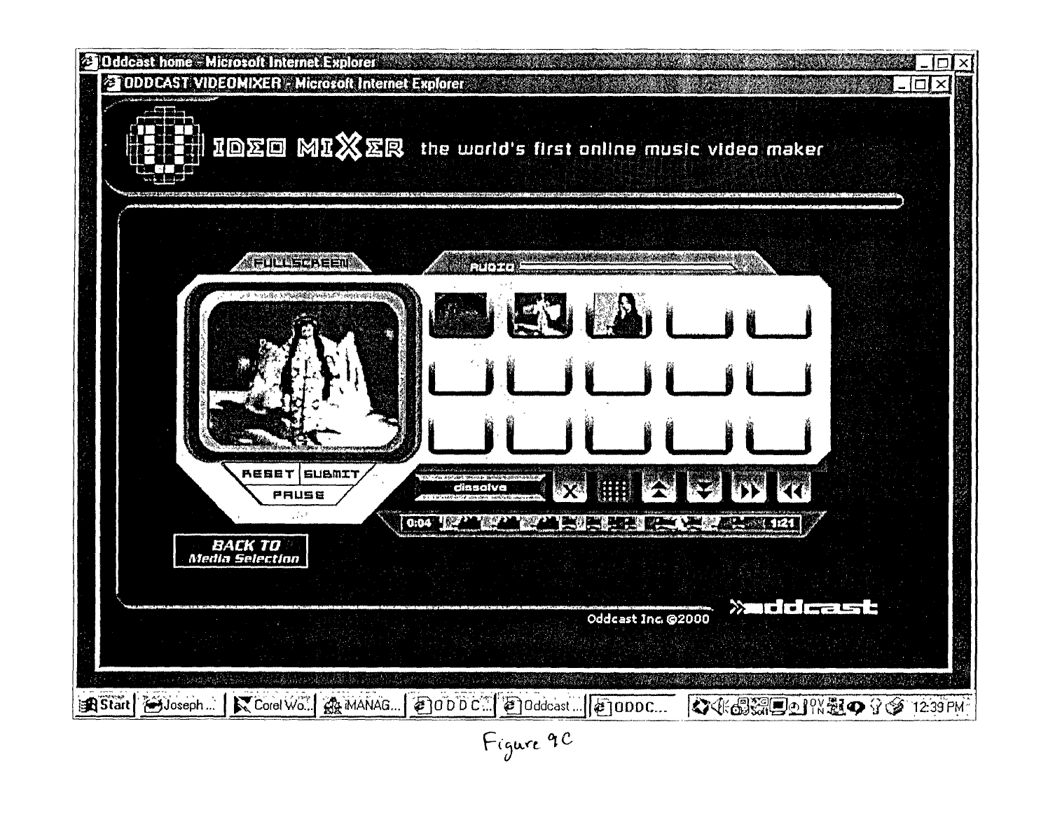

The GUI for allowing the end user to manipulate the video editor in the editing mode is illustrated in FIGS. 9A-9C. The editing mode is accessed as the final step of the mix your own clips application and gives a user full functionality including buttons for transitioning between the selected media. As can be seen in FIGS. 9A-9C, thumbnails of the previously selected media are shown in small windows at the video editor. To begin creating a video from the selected media, the user is prompted to click on one of the media thumbnails, which starts the timeline, keyed to the audio track, of the editor. Once the music starts, the user can, in real time, select which of the selected media is to be displayed at any particular point in the time line by clicking the corresponding thumbnail. The timing bar at the bottom of the editor keeps track of which media has been selected for each increment of the timeline.

Transition buttons are provided, to allow the end user to execute, from left to right, a cut transition, a dissolve, a push up, a push down, a push right, and a push left, Iris, checkers and additional transitions between a currently selected visual asset and the next one selected. That is, selection of a transition button affects the transition to the next different video thumbnail the user selects. These transitions can be seen on the main editing screen, which provides a running display of the video as it is being created. The present invention is not limited to the transitions shown in the exemplary pages and may include any well-known techniques, including all manner of wipes and fades, in addition to those mentioned above. As shown in FIG. 9B, during actual editing, the editor displays a stop recording button 272 that allows the user to stop the recording process at any time.

Once the time of the audio track has run out, the editor allows the user to view the completed video by clicking on the main editing screen on which the video has been displayed during editing. During playback, buttons are displayed around the editing screen showing options to show the video in full screen, to reset the video, to submit the video, that is, save it to the database and publish it, and to pause playback.

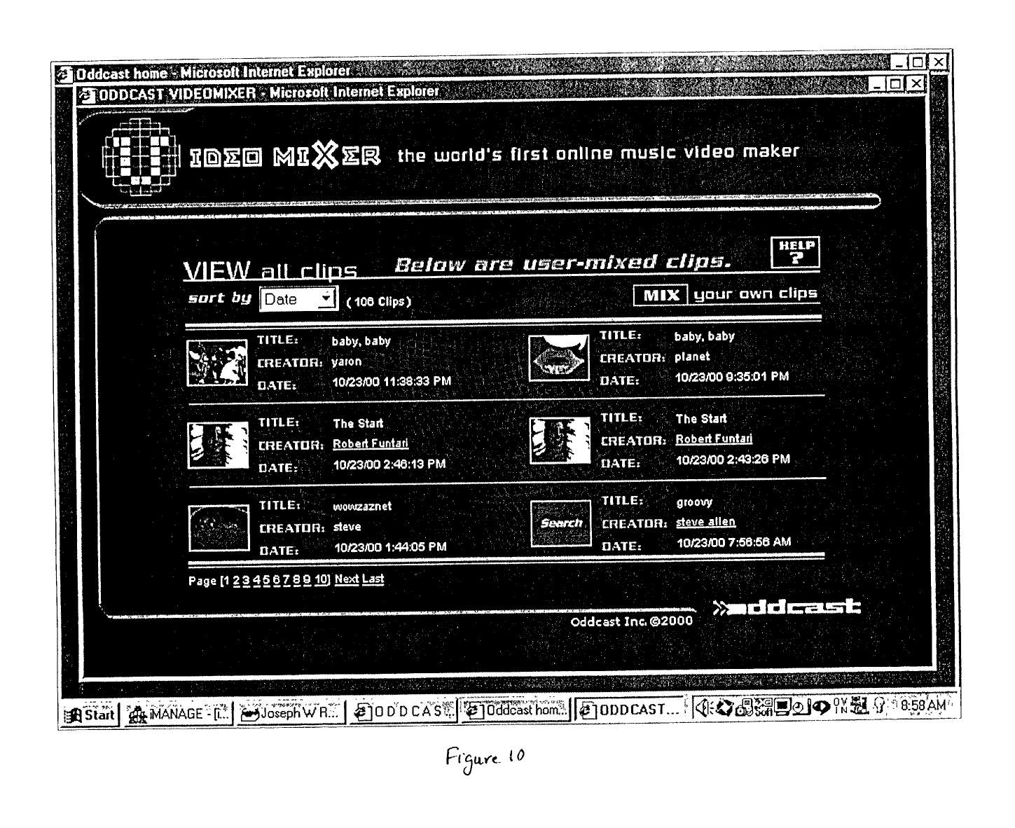

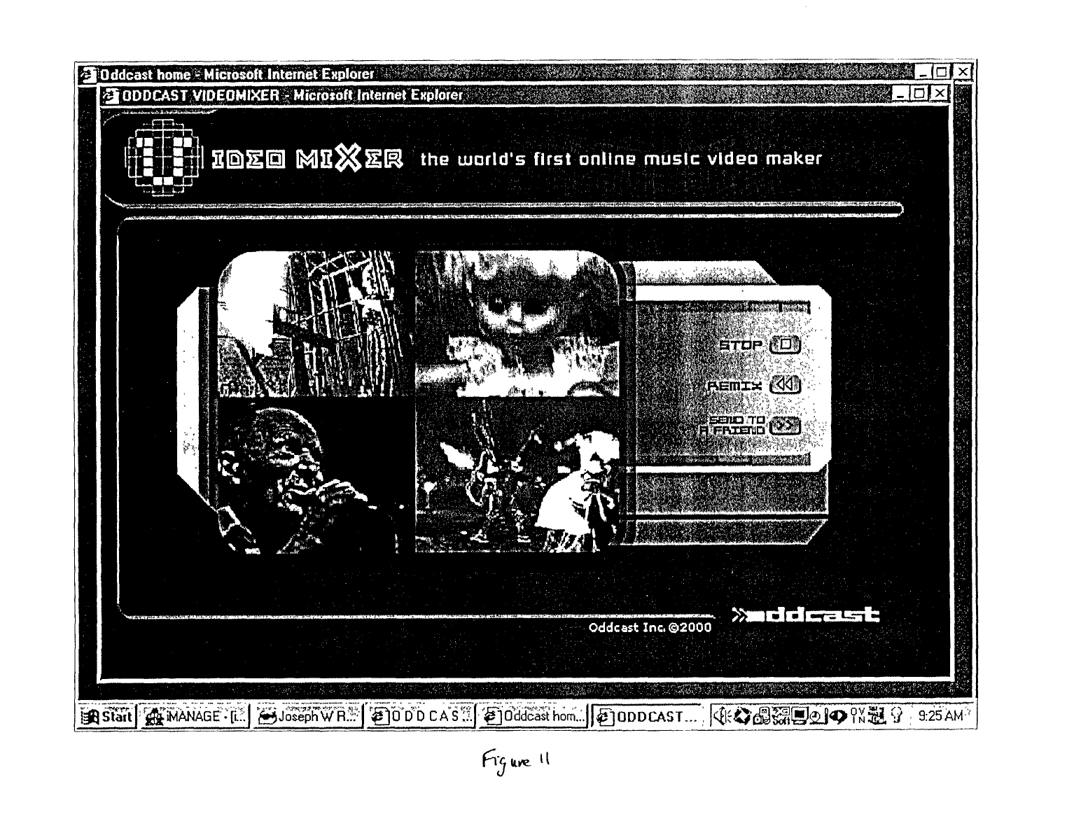

The foregoing paragraphs describe the pages presented to the end user during the mix your own clips application. Next, the view all clips application will be described. The graphical user interface page presented in response to selection of the view all clips application of the video editor is shown in FIG. 10. The view all clips application allows an end user to view all of the videos that have been created and posted at the Web site of the video editor. As can be seen from the figure, all previously saved clips are available for viewing. The page gives the user the option of viewing the clips as sorted by date, by title, or by creator, from a drop down menu. The help key is provided in this screen, the functionality of which is discussed below. The page also provides the user with a link to the mix your own clips application pages, which have been described above. The operation of the video editor of the present invention in the edit mode has been described above in connection with the mix your own clips application. In the view all clips application, the video editor is operated in its play mode. The page allowing the end user to interface with the video editor in the play mode is shown in FIG. 11. This mode of the video editor is accessed through the view all clips application and via an e-mail link. This mode allows users to view and e-mail other user's clips but preferably does not allow users to re-edit the clips viewed.

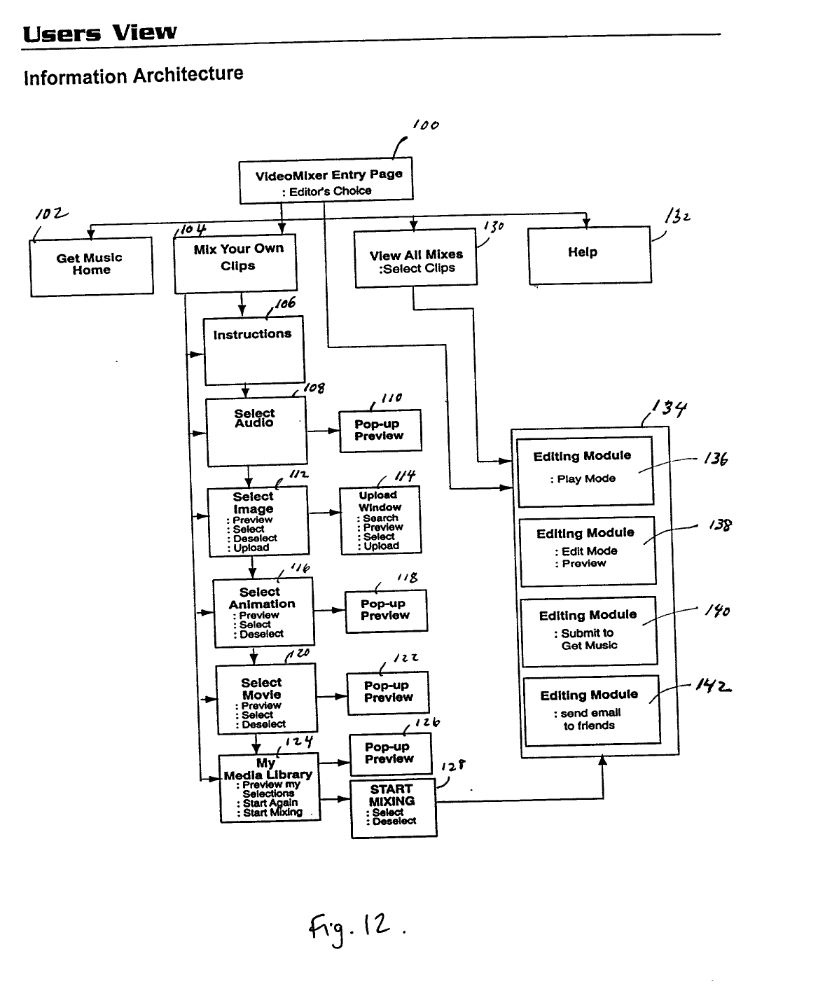

FIG. 12 illustrates the information architecture of the present invention from the point of view of the end user. The following information structures generally have corresponding GUI pages that have been described above.

Entry page 100 information structure, containing the editor's choice and other introductory information, is the first information structure encountered by a user. Links 102, mix your own clips 104, view all mixes 130 and help functionality 132 are information options made available to the user by the entry page information structure. Links structure 102 can contain links to related Web sites or other sites licensed to use the video editor of the present invention.

The mix your own clips information structure 104 allows the user to access, either sequentially or at random, the following information structures. An instructional information structure 106 provides the user information about the mixing process. A select audio information structure 108, with access to a pop up preview 110, allows the user to select the audio to be used in the video. A select image information structure 112 gives the user the option to preview, select, deselect, and upload still images for use in the video. An upload window 114 is accessible from the select image information structure 112, and allows the user to search, preview, select and upload images. A select animation information structure 116 allows the user to preview, select, and deselect animations to be used in the video. The select animation information structure also provides a pop-up preview information structure 118. A select movie information structure 120 allows the user to preview, select and deselect movies to be used in the video. The select movie information structure also provides a pop-up preview information structure 122. A my media library information structure 124 allows a users selected media to be previewed, allows the user to start editing again or to start mixing. For the purpose of previewing, the my media library information structure 124 provides access to pop-preview information structure 126. To mix the video after selection of the media, the my media library information structure 124 provides access to a start mixing information structure 128. The start mixing information structure 128 provides the user with the opportunity to access the editing module information structure 134.

The view all mixes information structure 130 allows a user to access the editing module information structure 134. The help information structure 132 allows the user to access helpful information to assist in using the video editor.

The editing module information structure 134 contains four sub-structures. The play mode 136, allows already existing videos to be played. The edit/preview mode 138 allows videos to be mixed from selected media. The submit to Web site mode 140 allows videos to be submitted to a Web site of the video mixer or an affiliated Web site. The send e-mail to friends mode allows a mixed video to be e-mailed to friends.

By virtue of the user controlled online video editor of the present invention, a user can create, in a matter of minutes, videos suitable for posting on a Web site, on television or e-mailing to friends. It should be noted that the GUI screens discussed above are simply illustrative. The present invention is not limited to the specific user interface structures and methods discussed above.

The foregoing description has focused on the GUI pages and information structures presented to the end user, i.e., a person wishing to create, and post, videos. The following description will generally be concerned with certain design considerations at the server side, including an administration tool that allows Web programmers to easily maintain and update a Web site housing the online editor of the present invention.

The view all clips application of the present invention is implemented using a series of ASP pages running in the server that function to let the end user access all the clips that have been uploaded to the database. As was discussed above in detail, this application functions to allow an end user to sort the previously mixed video clips by date, title and creator. Clips shown in this section can be taken offline by a system administrator at the server side.

The help application, which, as described above, may be accessed by clicking the help button visible on most of the pages discussed above, consists of flat HTML pages containing answers to frequently asked questions (FAQs) and links for the plug-ins required to use the video editor. The FAQs answered preferably include:

What is the video editor?

What do I need in order to use the video editor?

What does the video editor produce?

How do I view a clip in the video editor?

How do I create my own video clip?

How do I upload my own images to the video editor?

Tips for Mac users 8. Tips for AOL users

An explanation regarding the cookies mechanism.

The present invention preferably provides at the server an administration tool that allows Web programmers to upload assets, preview/censor user created assets and completed videos, and create contests though simple check box tools. The administration tool presents GUI pages for various maintenance and upgrade functions, allowing a system administrator, or technician, to administer the Web site. The Web site is structured so that the default page for the administration tool is the editor's choice page, which, as discussed above, contains the editor's recommendations for display at the Web site.

The administration tool is an HTML/JavaScript Web application implemented on the back end by means of ASP scripts. The implementation uses industry standard practices and tools to allow the site administrator to manage the content and users, review reports, statistics in the manner discussed herein.

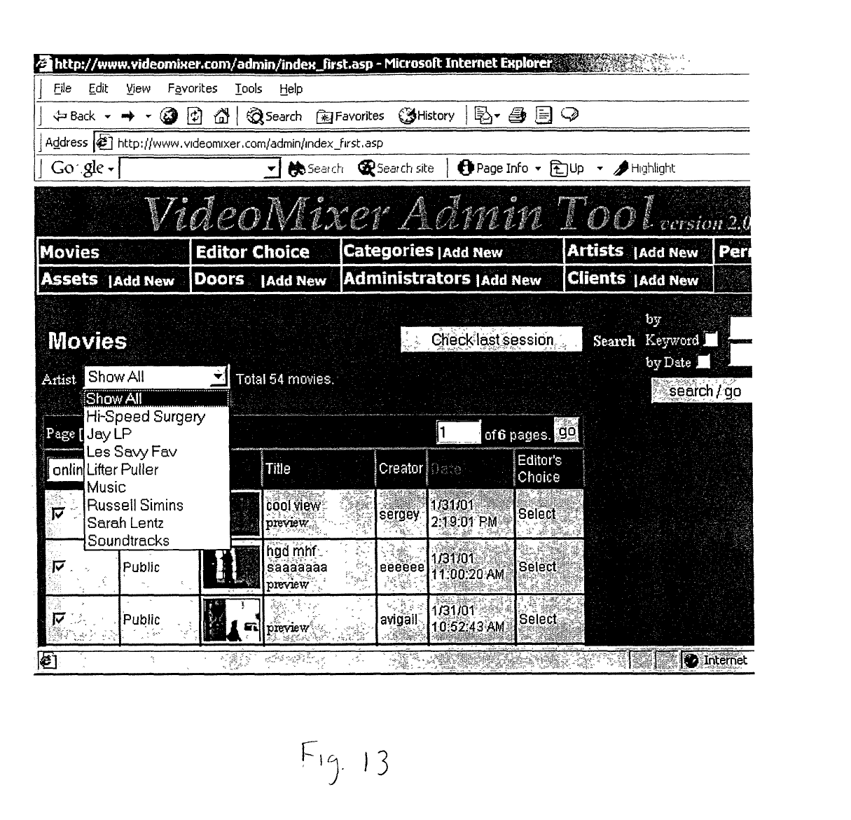

An example screen shot for the administration tool is shown in FIG. 13. The invention is not limited to such a screen. Any screen, or set of screens, that allow the technician to perform the functions discussed herein would be acceptable.

The administration tool preferably provides a pull-down menu to allow the administrator to toggle between a list of “upcoming” and “all” clips. A second pull-down menu preferably is provided to allow the administrator to sort the clips by the following parameters:

Date (default)

Title of Clip

Creator

Editor's Choice

The list audio page preferably is structured at the server side the same way as the editor's choice page. Preferably, an administrator of the Web site of the present invention can use a first pull-down menu to toggle between listing “online” and “offline” clips. A second pull-down menu lets the user sort the clips by date song title or creator. In order to add new audio files to the database, a technician must first upload the files to the following directory in the content server, using FTP or Microsoft file sharing.

Server name: Vmix_cont

Folder: E:\media\new_audio

Or FTP to: [IP address TBA]\media\new_audio

Once the files have been uploaded, the technician can go to an “Add: Audio” page in the administration tool, at which page appears a listing for the new audio clips.

When an audio file is saved by technician, for example to add a new file for selection by end users, the space character preferably is not used in the file name and the file is named with the file extension, “.swf”. An underscore preferably is used between words and the name of the song typed exactly as a technician at the server side would like it to appear on-line. So as not to burden the end user with information he or she would not be interested in, the extension: “.swf” will automatically not appear on-line.

At that point a GUI screen will give the technician the opportunity to update the following fields:

Title: The technician should be certain to title the name of the file exactly the way the technician would like the title of the song to appear on-line. For example: Show_Me_Your_Wild_Side.swf. The extension “.swf’ will not appear on the online listing.

Artist: An artist can be selected from a pull-down menu or a new artist name added by typing it in the text field beside the artist pull-down menu.

mm:ss: The technician may type in the length of the track by inputting the number of minutes and seconds in the fields provided.

The technician then will be provided the opportunity to click check boxes for the files that he or she wants immediately to be updated to the video mixer application or to use the “Select All”, “Select None” and “Clear All”. The technician may click “Add” to finish the procedure once he or she is satisfied with his or her choices. Note that clicking “add” on the “add” page immediately takes that particular audio clip online. If the fields are not filled-in properly, then the changes will not take effect.

To take an audio clip offline, the technician may select “List: Audio” and select “Online” from the first pull-down menu. Then, the technician simply unchecks the check box next to the name of the audio clip. Once all the changes have been made, the technician clicks “update” and his or her changes will become effective immediately.

To make an offline audio clip available online, the technician selects “Offline” from the pull-down menu from the “List Audio” page. If the title of the audio clip the technician wants is listed on that page, he or she can simply check the check box next to the title and click “update” to make the modifications take effect. If the title of his or her audio clip is not listed in the online and offline list then the technician will need to “add” the audio clip to the database.

To list visual elements used within the video editor of the present invention, the technician clicks on the “List” link of “Visual Elements” in the top menu bar. Once there, the technician will be able to choose from an online and offline list of visual elements via the first pull-down menu.

The visual elements are broken down into the following:

image (jpeg)

movie (an swf file converted Quicktime movie, plus a representative jpeg)

animation (an swf file—Flash element, plus a representative jpeg)

user upload (user uploaded jpegs)

In order to add new visual elements to the database, the technician must first upload the files to the following directory in the content server, using FTP or Microsoft file sharing.

For still images:

Server name: Vmix_cont

Folder: E:\media\new_image

Or FTP to: [IP address TBA]\media\new_image

For movies:

Server name: Vmix_cont

Folder: E:\media\new_movie

Or FTP to: [IP address TBA]\media\new_movie

In addition to the swf movie, a representative image (jpeg, recommended size 240X180 pixels) should be uploaded to:

E:\media\new_movie\thumbnail

For animations:

Server name: Vmix_cont

Folder: E:\media\new animation

Or FTP to: [IP address TBA]\media\new_animation

In addition to the swf movie, a representative image (jpeg, recommended size 240X180 pixels) should be uploaded to:

E:\media\new animation\thumbnail

Once the technician has uploaded the files, he or she can go to the “Add: Visual Elements” page in the administration tool and select the relevant folder from the first pull-down menu. If the technician has uploaded the element correctly then he or she should see a thumbnail of the corresponding element together with the name of that element.

The technician can check the checkbox next to any item that he or she wants to add online or leave some unchecked to add at a later date. The visual elements will remain in the “New” folder until they have been checked and updated. Once they have been brought online, they will be automatically removed from that “new” folder.

To take a visual element offline, the technician should select “Online” from the first pull-down menu, then choose the type of visual element that he or she wants to update from the second pull-down menu. The technician may uncheck any of the check boxes next to the thumbnail of the element the technician wants to take offline. Once the technician is done with all the changes, he or she may click on “Update” to make the changes take effect.

When the image is saved, the space character should not be used in the file name and the file should be named with the file extension “.jpg”.

To make a visual element available online: the technician should select “Offline” from the first pull-down menu in the “List Visual Elements” page. Then the technician should select the visual element type from the second pull-down menu. If the element that the technician wants to make available is listed there, the technician should just check the checkbox next to the thumbnail and click the “Update” button. The list is sorted according to the date of the upload. If the technician's element is not listed in the “Offline” lists, then the technician will have to click on the “Add” link from the menu bar and follow steps accordingly.

To edit the Editor's Choice, the technician can click on the “Editor's Choice: List” menu option. Once there, the technician can choose to view “Upcoming” or “All” from the first pull-down menu. The technician can also sort his or her list via a second pull-down menu by Date, Title, Creator, or Editor's Choice. From these pages, the technician will see a list of selected clips. The technician can deselect clips by checking the checkbox, or edit the publish date of the clip for editor's choice and the accompanying text by clicking on the “Edit” link next to the clip's thumbnail.

To add a new clip to the Editor's Choice list, the technician can go to the “Users° Clips” page (accessed from the top menu bar). One of the links for each clip is the “Add” function for Editor's Choice. Once the technician has clicked on this, a pop-up window will appear allowing the technician to select a publishing date, and also type in an accompanying caption or Editor's Comments. The length of the text to go to this text field depends on the design parameters of the video editor homepage. Generally, the text should be approximately one short paragraph/caption.

To add a new contest/competition, an administrator technician should go to the “competitions” from the administrator's page (accessed from the top menu bar), then check/uncheck contests, modify the description of the contest by filling up the white text field and hit update.

When an animation is saved, the space character should not be used in the file name and the technician should name it with the file extension .swf. For the accompanying 240×180 thumbnail, the same file name should be used but with file extension .jpg and saved under 240×180 thumbnail folder.

For example:

subway.swf

240×180 thumbnail/subway.jpg

The present invention allows the administrator/editor to select clips for publishing up to five weeks ahead of the date of clip selection.

As has been describe in considerable detail above, the present invention provides users with an online experience that includes the ability to interact creatively with branded audio and visual content. The present invention also allows users to include their own content in combination with, or instead of, the branded content. Said interaction results in edit decision lists, which allow efficient storage and optimization to the playback environment.

The illustrated examples discussed above have been described in terms of the preferred embodiments. It is to be understood, however, that the invention is not limited to those embodiments, examples, and systems, and that various changes and modifications may be made by those of ordinary skill in the art without departing from the spirit and the scope of the appended claims.

What is claimed is:

1. An apparatus operating on a network having a client/server architecture to allow a client control over a video editor program running on the server, the apparatus comprising:
means for receiving from a client user choices for audio/visual media available on the server and/or audio/visual media uploaded from the client;
means for presenting the client with a real time control panel to allow the client to control the video editor program to create a video from the chosen and/or uploaded audio/visual media;
means for streaming audio and video content to the client in real time to allow the video to be played by the client as it is being created; and
means for saving the completed video in the form of one or more edit decision lists without having to store the constituent media, allowing for efficient storage and optimized playback.

2. An apparatus according to claim 1, further comprising means for displaying the completed video from the edit-decision list.

3. An apparatus according to claim 2, wherein the media used to display the completed video may be of a higher resolution than that which was played back to the user by said streaming means.

4. An apparatus according to claim 1, further comprising means for selecting completed videos that will be awarded a prize.

5. An apparatus according to claim 4, wherein the video that is awarded the prize is played on television in high resolution format.

6. A method running on a server operating on a network having a client/server architecture to allow a client control over a video editor program running on the server, the method comprising:
receiving from a client user choices for audio/visual media available on the server and/or audio/visual media uploaded from the client;
presenting the client with a real time control panel to allow the client to control the video editor program to create a video from the chosen and/or uploaded audio/visual media;
streaming audio and video content to the client in real time to allow the video to be played by the client as it is being created; and
saving the completed video in the form of one or more edit decision lists without having to store the constituent media, allowing for efficient storage and optimized playback.

7. A method according to claim 6, further comprising means for displaying the completed video from the edit-decision list.

8. A method according to claim 7, wherein the media used to display the completed video may be of a higher resolution than that which was played back to the user at said streaming step.

9. A method according to claim 6, further comprising selecting completed videos that will be awarded a prize.

10. A method according to claim 9, wherein the video that is awarded the prize is played on television in high resolution format.

11. A computer-readable medium for controlling a processor controlled server operating on a network having a client/server architecture, the server allowing a client control over a video editor program running on the server, to perform a method comprising:
receiving from a client user choices for audio/visual media available on the server and/or audio/visual media uploaded from the client;
presenting the client with a real time control panel to allow the client to control the video editor program to create a video from the chosen and/or uploaded audio/visual media;
streaming audio and video content to the client in real time to allow the video to be played by the client as it is being created; and
saving the completed video in the form of one or more edit decision lists without having to store the constituent media, allowing for efficient storage and optimized playback.

12. A computer-readable medium according to claim 11, the method further comprising displaying the completed video from the edit-decision list.

13. A computer-readable medium according to claim 12, wherein the media used to display the completed video may be of a higher resolution than that which was played back to the user at said streaming step.

14. A computer-readable medium according to claim 11, the method further comprising selecting completed videos that will be awarded a prize.

15. A computer-readable medium according to claim 14, wherein the video that is awarded the prize is played on television in high resolution format.

16. A server operating on a network having a client/server architecture to allow a client control over a video editor program running on the server, the server being adapted to:
receive from a client user choices for audio/visual media available on the server and/or audio/visual media uploaded from the client;
present the client with a real time control panel to allow the client to control the video editor program to create a video from the chosen and/or uploaded audio/visual media;
stream audio and video content to the client in real time to allow the video to be played by the client as it is being created; and
save the completed video in the form of one or more edit decision lists without having to store the constituent media, allowing for efficient storage and optimized playback.

17. A server according to claim 16, further adapted to display the completed video from the edit-decision list.

18. A server according to claim 17, wherein the media used to display the completed video may be of a higher resolution than that which was played back to the user during streaming.

19. A server according to claim 16, further adapted to select completed videos that will be awarded a prize.

20. A server according to claim 19, wherein the video that is awarded the prize is played on television in high resolution format.

21. An apparatus, comprising a server processor coupled to a user via an on-line connection, said server processor being adapted to:
allow the user to edit audio/video content online; and
create an edit list of edits with the edit list stored on the server processor.

22. An apparatus according to claim 21, wherein the content and edit list substitute for composed content created via the user edits.

23. An apparatus according to claim 21, wherein the server processor edits the content using the edit list when edited content is requested.

24. An apparatus according to claim 21, further comprising an interface processor receiving an edit control interface from the server processor and the user editing the content using the interface.

25. An apparatus, comprising:
a server processor, the server processor being adapted to:
(a) store audio/video content and an edit list for the content;
(b) transmit an edit control interface used for communicating with the server processor; and
(c) create the edit list and download edited content when requested by editing the content with the edit list; and
a client processor coupled to the server processor, the client processor being adapted to receive the interface, and allow a user to on-line edit the content stored on the server processor using the interface and create the edit list.

26. A method comprising:
allowing a user to interactively edit remotely stored audio/video content producing an edit list; and
storing the edit list remotely in association with the content.

27. A method according to claim 26, further comprising downloading edited content on request by applying the edit list to the content.

28. A method according to claim 27, further comprising optimizing the edited content responsive to a download destination.

29. A method according to claim 26, wherein the content and edit list substitute for composed content created via user edits.
